(19) United States
(12) Patent Application Publication
(10) Pub. No.: US 2020/0036268 A1
(43) Pub. Date: Jan. 30, 2020

(54) VEHICLE

(71) Applicant: HONDA MOTOR CO., LTD., Tokyo (JP)

(72) Inventors: Keisuke AZUSAWA, Saitama (JP); Masashi Inoue, Saitama (JP)

(73) Assignee: HONDA MOTOR CO., LTD., Tokyo (JP)

(21) Appl. No.: 16/519,763

(22) Filed: Jul. 23, 2019

(30) Foreign Application Priority Data
Jul. 24, 2018 (JP) 2018-138834

(51) Int. Cl. H02K 11/26; H02K 3/12; H02K 3/34; H02K 7/00; H02K 11/25; H02K 11/33; H02K 11/35; G07C 5/08

(52) U.S. Cl. CPC H02K 11/26; H02K 3/12; H02K 3/34; H02K 7/006; B60L 15/00; H02K 11/33; H02K 11/35; G07C 5/0825; G07C 5/0833; H02K 11/25

(57) ABSTRACT

A vehicle comprises an electric motor, an electric motor control device which controls electric power to be supplied to the electric motor, an atmospheric pressure detection part which detects atmospheric pressure, and a storage part which stores the number of times that a voltage exceeding a partial discharge inception voltage set according to the atmospheric pressure detected by the atmospheric pressure detection part is input to the electric motor.

### CROSS-REFERENCE TO RELATED APPLICATIONS

This application is based on and claims priority under 35 USC 119 from Japanese Patent Application No. 2018-138834 filed on Jul. 24, 2018.

### TECHNICAL FIELD

The present invention relates to a vehicle which includes an electric motor as a driving source.

### BACKGROUND ART

In recent years, a hybrid vehicle, an electric vehicle, or the like which travels by a driving force of an electric motor has attracted attention. In such a vehicle, a power control device such as an inverter for supplying electric power to the electric motor is mounted, and the electric motor is driven at a high voltage.

Meanwhile, the vehicle in which the electric motor is mounted travels at high altitudes in some cases. At high altitudes, particularly, atmospheric pressure is low, and air density decreases under such an environment. When the air density decreases, there is a problem that a partial discharge inception voltage decreases in the electric motor. When the partial discharge inception voltage decreases, there are problems that insulation performance of an insulator is deteriorated and further a durable life is deteriorated.

In JP-A-2006-288170, a technique is proposed in which the generation of the partial discharge is controlled by setting the voltage value supplied to the motor and the inverter according to the detected atmospheric pressure.

### SUMMARY

However, in the control according to JP-A-2006-288170, since the voltage value is limited according to the atmospheric pressure, when the altitude is high, there is a concern that the output of the electric motor is always limited instead of generating the maximum output thereof. Particularly, in consideration of sensor errors, there may be situations in which the output of the electric motor must be limited even in a state where the altitude is not so high.

The invention provides a vehicle capable of avoiding an output limit of an electric motor by recognizing the durable life of the electric motor.

An embodiment of the present invention relates to a vehicle comprising:

an electric motor;

an electric motor control device which controls electric power to be supplied to the electric motor;

an atmospheric pressure detection part which detects atmospheric pressure; and

a storage part which stores the number of times that a voltage exceeding a partial discharge inception voltage set according to the atmospheric pressure detected by the atmospheric pressure detection part is input to the electric motor.

According to the invention, the storage part stores the number of times that a voltage exceeding the partial discharge inception voltage set according to the atmospheric pressure detected by the atmospheric pressure detection part is input to the electric motor, thereby recognizing the durable life of the electric motor. When the durable life of the electric motor is recognized as described above, the output of the electric motor can be controlled not to be limited until the durable life of the electric motor is close to the end.

### BRIEF DESCRIPTION OF DRAWINGS

FIG. 1 is a conceptual view of a main portion of a vehicle according to an embodiment of the invention;

FIG. 2 is a perspective view of an electric motor as a driving source;

FIG. 3A is an enlarged partial view of one end-side stator core of the electric motor of FIG. 2;

FIG. 3B is an enlarged partial view of the other end-side stator core of the electric motor of FIG. 2:

FIG. 3C is another enlarged partial view of the other end-side stator core of the electric motor of FIG. 2:

FIG. 4 is a flow chart of an electric motor protection control;

FIG. 5 is a graph illustrating a relationship between a generated voltage and a partial discharge inception voltage; and

FIG. 6 is a life curve graph illustrating a relationship between a partial discharge inception voltage and the number of times of replacement-recommendations.

### DESCRIPTION OF EMBODIMENTS

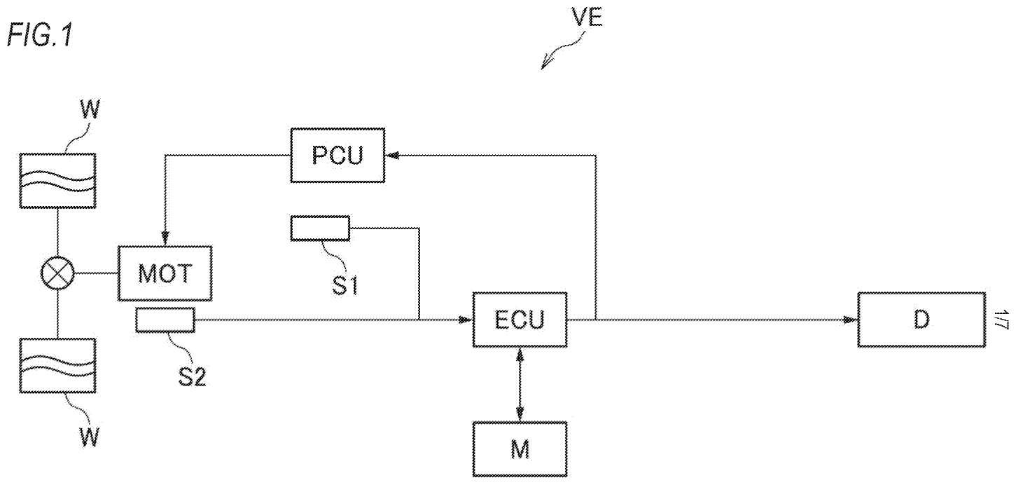

Hereinafter, a vehicle according to an embodiment of the invention will be described. As illustrated in FIG. 1, a vehicle VE of the embodiment includes an electric motor MOT as a driving source, an electric motor control device ECU which controls electric power supplied to the electric motor MOT, a power conversion device PCU which converts the electric power supplied to the electric motor MOT, an atmospheric pressure detection part S1 which detects atmospheric pressure, a temperature detection part S2 which detects temperature of the electric motor MOT, a storage part M, and a notification part D.

For example, the electric motor MOT is a three-phase AC synchronous motor and is connected to driving wheels W of the vehicle VE to generate the driving force according to the supplied AC voltage to the driving wheels W.

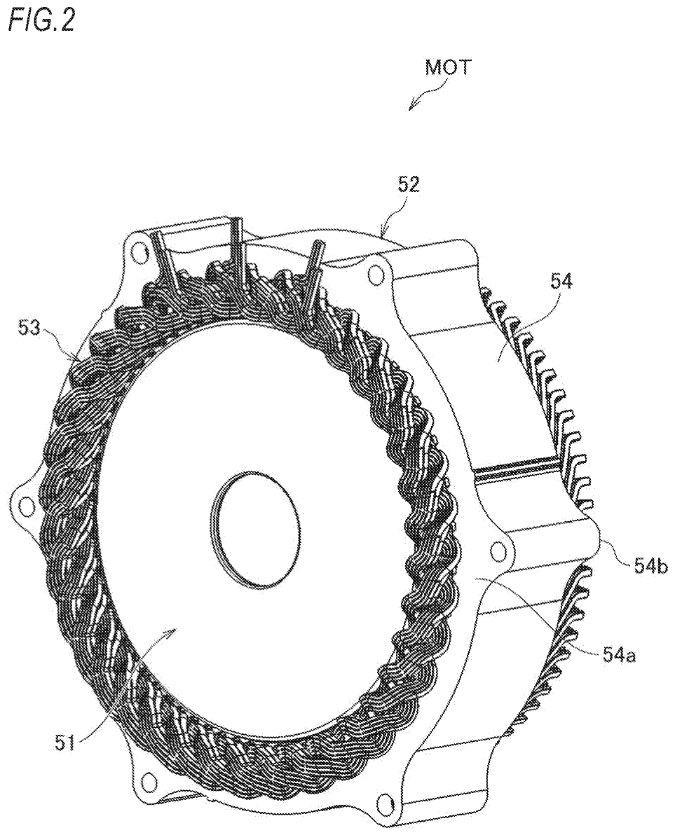

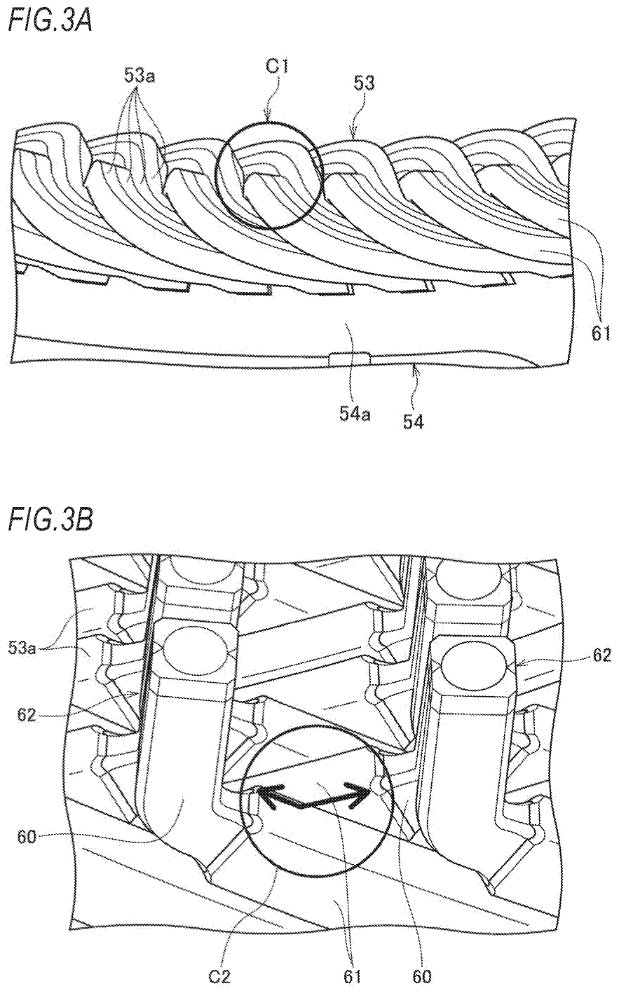

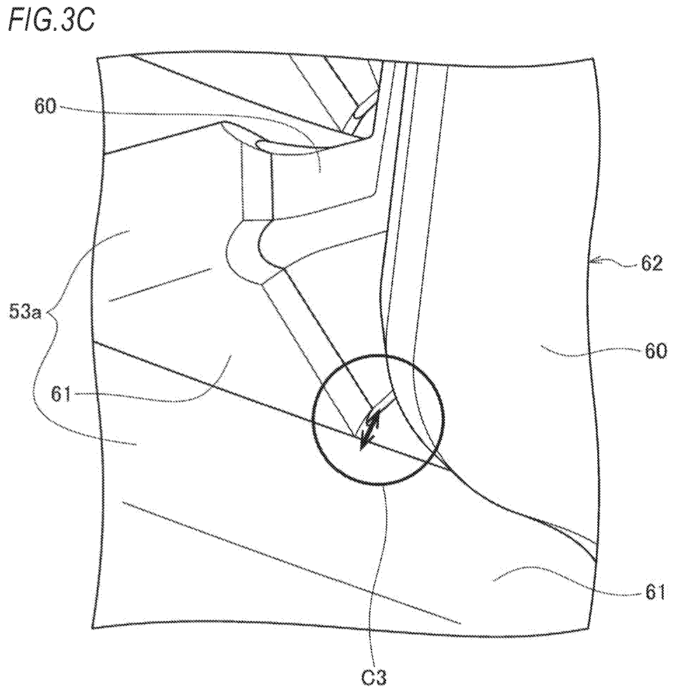

As illustrated in FIG. 2, the electric motor MOT is a so-called inner rotor type electric motor which includes a rotor 51 and a stator 52 which is arranged to face the outer diameter side of the rotor 51 through a slight gap. In the stator 52, a coil 53, which is configured by covering a conductor 60 with an insulating film 61, is wound (see FIGS. 3B and 3C).

As illustrated in FIGS. 3A to 3C, the coil 53 is configured by a plurality of U-shaped coil segments 53a. In the electric motor MOT of the embodiment, the four U-shaped coil segments 53a are inserted sequentially into slots from one end surface 54a side of the stator core 54. The end portions of the coil segments 53a projecting from another end surface 54b side of the stator core 54 are joined (for example, welded) together by a joint part 62 from which the insulation film 61 is peeled off.

As illustrated in FIG. 3A, in the one end surface 54a side of the stator core 54, the conductor 60 of each coil segment 53a is insulated by both insulating films 61 covering the conductor 60 (hereinafter, the portion illustrated in FIG. 3A is referred to as a coil superimposing part C1.). As illustrated in FIG. 3B, the other end surface 54b side of the stator core 54 has a portion (hereinafter, the portion illustrated in FIG. 3B is referred to as a coil creeping surface part C2.) in which the joint parts 62 are insulated from each other by the surfaces of the intersecting insulating films 61 and a portion (hereinafter, the portion illustrated in FIG. 3C is referred to as a coil intersection part C3.) in which the joint part 62 from which the insulating film 61 is peeled off and the conductor 60 covered with the insulating film 61 are intersected and are insulated by the interposed insulating film 61. Those portions have different partial discharge inception voltages PDIV depending on the number and the insulation distance of the interposed insulating films.

The temperature detection part S2 is a temperature sensor which detects the temperature of the coil 53 of the electric motor MOT. Preferably, a plurality of temperature detection parts S2 are provided to be arranged one by one in each of the coil superimposing part C1, the coil creeping surface part C2, and the coil intersection part C3. The temperature detection part S2 transmits a detection signal corresponding to the detected temperature to the electric motor control device ECU.

The atmospheric pressure detection part S1 is an atmospheric pressure sensor which detects the atmospheric pressure surrounding the vehicle VE. The atmospheric pressure detection part S1 transmits a detection signal corresponding to the detected atmospheric pressure to the electric motor control device ECU.

The electric motor control device ECU controls the electric power to be supplied to the electric motor MOT based on various information (for example, an accelerator opening degree or the like) detected by various sensors.

The power conversion device PCU includes a DC-DC converter circuit which boosts DC power and an inverter circuit which converts the DC power into AC power. The power conversion device PCU boosts the DC power according to a control signal received from the electric motor control device ECU to convert the boosted DC voltage into AC voltage.

Herein, when the vehicle VE travels, according to the operation of the electric motor MOT, a partial discharge may occur in an inner insulator, particularly, the insulating film 61 of the coil 53. The partial discharge inception voltage changes according to the change of the atmospheric pressure. That is, when the vehicle VE travels under the environment of low atmospheric pressure, such as high altitudes, the partial discharge inception voltage decreases. The insulation performance of the insulating film 61 of the coil 53 may be deteriorated due to the decrease of the partial discharge inception voltage.

However, in the design stage of the electric motor MOT, the insulation performance of the electric motor MOT is guaranteed until the insulating film 61 of the coil 53 is deteriorated to a predetermined extent. In other words, as long as a voltage below the partial discharge inception voltage PDIV is supplied to the electric motor MOT, the insulating film 61 of the coil 53 is not deteriorated, or the deterioration of the insulating film 61 of the coil 53 is negligible. In addition, if a voltage exceeding the partial discharge inception voltage PDIV is supplied to the electric motor MOT, the electric motor MOT can be used as usual until the number of times that a voltage exceeding the partial discharge inception voltage PDIV is input to the electric motor MOT exceeds a predetermined number of times (hereinafter, referred to as a replacement-recommendation count). On the other hand, after the number of times that a voltage exceeding the partial discharge inception voltage PDIV is input to the electric motor MOT exceeds the replacement-recommendation count, it is necessary to recognize that the durable life of the electric motor MOT is close to the end.

In this regard, the storage part M stores the number of times (hereinafter, referred to as the number of excess times) that a voltage exceeding the partial discharge inception voltage PDIV set according to the atmospheric pressure detected by the atmospheric pressure detection part S1 is input to the electric motor MOT. The storage part M can recognize the durable life of the electric motor MOT by storing the excess times. When the durable life of the electric motor MOT is recognized as described above, the output of the electric motor MOT can be controlled not to be limited until the durable life of the electric motor MOT is close to the end.

The electric motor control device ECU does not limit the electric power to be supplied to the electric motor MOT until the number of excess times exceeds the replacement-recommendation count. Accordingly, the deterioration of the electric motor MOT is regarded as small until the number of excess times exceeds the replacement-recommendation count, and an occupant can drive the vehicle VE without receiving the output limit of the electric motor. On the other hand, after the number of excess times exceeds the replacement-recommendation count, the electric motor control device ECU regards that the electric motor MOT is near the end of the durable life and limits the voltage to be supplied to the electric motor MOT. Accordingly, it is possible to reduce further deterioration of the electric motor MOT near the end of the durable life.

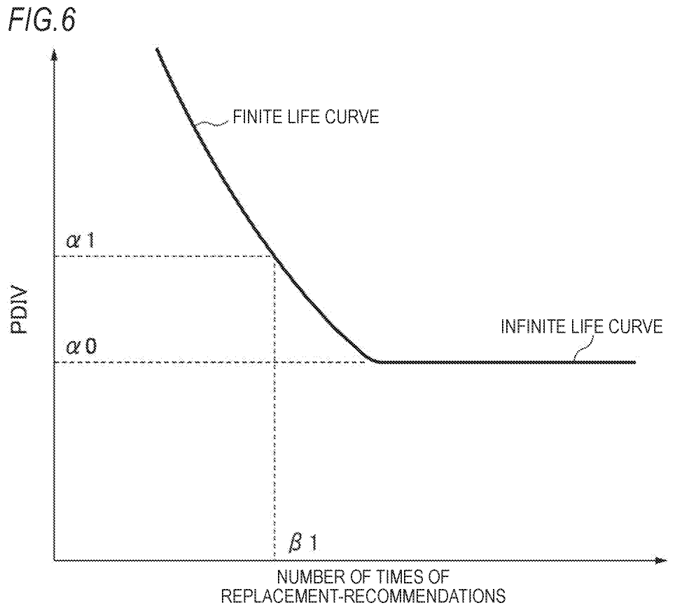

For example, the replacement-recommendation count is derived from the life curve graph illustrated in FIG. 6. The life curve graph is configured by a finite life curve and an infinite life curve. When the generated voltage is α0 or less, the replacement-recommendation count is not set, and when the generated voltage is larger than α0 (for example, α1), the replacement-recommendation count (for example, β1) is set from an intersection point between the PDIV and the finite life curve. For example, β1 is 1.0 to 9.0×10⁹ times.

When the number of excess times exceeds the replacement recommendation count, the notification part D notifies the occupant according to the control signal received from the electric motor control device ECU. The notification part D may be a visible display part or a speaker generating warning sound. The display part may be a display screen of a car navigation system, a lamp provided in an inner panel of the vehicle VE, or the like.

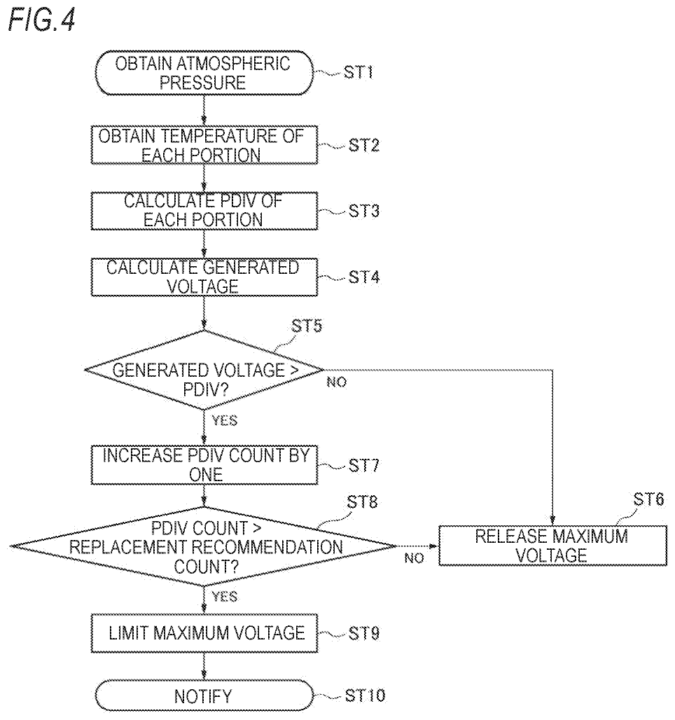

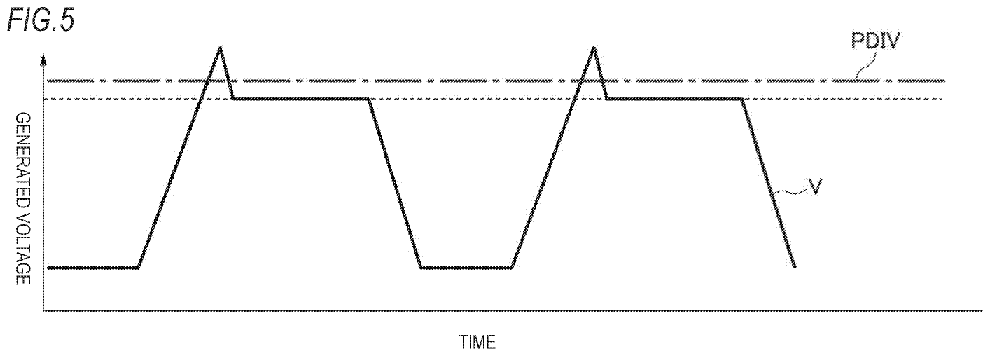

Hereinafter, a motor protection controlling method by the electric motor control unit ECU will be described based on FIG. 4. First, the electric motor control device ECU obtains the atmospheric pressure surrounding the vehicle VE detected by the atmospheric pressure detection part S1 (ST1) and then, the temperature of each portion (the coil superimposing part C1, the coil creeping surface part C2, and the coil intersection part C3) (ST2). Since the partial discharge inception voltage PDIV varies according to the atmospheric pressure and the temperature of each portion, the partial discharge inception voltage PDIV can be calculated more accurately by grasping the atmospheric pressure and the temperature of each portion.

Subsequently, the electric motor control device ECU calculates the partial discharge inception voltage PDIV of the coil 53 (ST3). As described above, the partial discharge inception voltage PDIV of the coil 53 is different for each portion and varies according to the atmospheric pressure and the temperature of each portion. Therefore, the partial discharge inception voltage PDIV is derived from the following Expression (1).

Partial discharge inception voltage PDIV=base PDIV of each portion×barometric coefficient×temperature coefficient (1)

For example, a PDIV base map of each portion is stored in advance in the electric motor control device ECU, and the base PDIV of each portion is derived by accessing the PDIV base map.

Subsequently, the electric motor control device ECU calculates the generated voltage which is generated in the coil 53 (ST4). The generated voltage V is a voltage actually generated in the coil 53 of the electric motor MOT. As illustrated in FIG. 5, the voltage input to the electric motor MOT includes a pulsation and a surge voltage. Therefore, the generated voltage V is derived from the following Expression (2).

Generated voltage V=(indicated voltage+voltage ripple)×surge magnification (2)

Subsequently, the electric motor control device ECU compares the derived partial discharge inception voltage PDIV and the generated voltage V generated in the coil 53 of the electric motor MOT (ST5) and releases a maximum voltage to be input to the electric motor MOT if the generated voltage V does not exceed the partial discharge inception voltage PDIV (ST6). That is, the voltage boosted according to the control signal received from the electric motor control device ECU is input from the power conversion device PCU to the electric motor MOT.

On the other hand, if the generated voltage V exceeds the partial discharge inception voltage PDIV, the PDIV count of the storage part M is increased by one (ST7).

Then, the electric motor control device ECU compares the PDIV count and the replacement-recommendation count (ST8) and releases the maximum voltage to be input to the electric motor MOT if the PDIV count does not exceed the replacement-recommendation count (ST6).

On the other hand, if the PDIV count exceeds the replacement-recommendation count, the electric motor control device ECU limits the maximum voltage to be input to the electric motor MOT (ST9). That is, the electric motor control device ECU limits the maximum voltage to be input to the electric motor MOT, sets the optimum voltage within a limit range, and instructs the optimum voltage to the power conversion device PCU.

The electric motor control device ECU limits the maximum voltage to be input to the electric motor MOT (ST9) and transmits the control signal to urge the notification part D to replace the stator 52. The notification part D notifies the occupant to replace the stator 52 (ST10).

The above-described embodiment can be modified and improved as appropriate. For example, in the embodiment, a case is exemplarily described in which the partial discharge inception voltage PDIV is monitored at each portion. However, the partial discharge inception voltage PDIV only at the portion most apt to discharge, such as the coil intersection part C3, may be monitored.

The description in this specification includes at least the following. Although corresponding components or the like in the above-described embodiments are indicated in the parentheses, the invention is not limited thereto.

(1) A vehicle (vehicle VE) including:

an electric motor (electric motor MOT);

an electric motor control device (electric motor control device ECU) which controls electric power to be supplied to the electric motor;

an atmospheric pressure detection part (atmospheric pressure detection part S1) which detects atmospheric pressure; and

a storage part (storage part M) which stores the number of times (the number of excess times) that a voltage exceeding a partial discharge inception voltage (partial discharge inception voltage PDIV) set according to the atmospheric pressure detected by the atmospheric pressure detection part is input to the electric motor.

According to (1), the storage part stores the number of times that a voltage exceeding the partial discharge inception voltage set according to the atmospheric pressure detected by the atmospheric pressure detection part is input to the electric motor, and thus, the durable life of the electric motor can be recognized. When the durable life of the electric motor is recognized as described above, the output of the electric motor can be controlled not to be limited until the durable life of the electric motor is close to the end.

(2) In the vehicle according to (1),

the electric motor control device limits a voltage to be supplied to the electric motor if the number of times stored in the storage part exceeds a predetermined number of times (replacement-recommendation count).

According to (2), since the electric motor control device limits the voltage to be supplied to the electric motor if the number of times stored in the storage part exceeds the predetermined number of times, it is possible to reduce further deterioration of the electric motor near the end of the durable life. On the other hand, since the electric motor control device does not limit the electric power to be supplied to the electric motor until the number of times stored in the storage part exceeds the predetermined number of times, the occupant can drive the vehicle without receiving the output limit of the electric motor. In addition, since the partial discharge is allowed until the number of times stored in the storage part exceeds the predetermined number of times, and the output of the electric motor is limited after the number of times exceeds the predetermined number of times, and, therefore, the degree of freedom in the design of the electric motor can be secured. That is, the thickness of the insulating film of the coil may be reduced, the cross-sectional area of the conductor may be increased, and the tooth width of the stator may be increased.

(3) The vehicle according to (2) further includes:

a power conversion device (power conversion device PCU) which converts the electric power to be supplied to the electric motor, wherein

the electric motor control device limits a boosting voltage output by the power conversion device.

According to (3), since the output boosting voltage is limited by the electric motor control device, it is possible to more reliably reduce the deterioration of the electric motor near the end of the durable life.

(4) The vehicle according to any one of (1) to (3) further includes:

a temperature detection part (temperature detection part S2) which detects temperature, wherein

the partial discharge inception voltage is set based on the atmospheric pressure detected by the atmospheric pressure detection part and the temperature detected by the temperature detection part.

According to (4), since the partial discharge inception voltage is set based on the atmospheric pressure and the temperature, the partial discharge inception voltage can be set more appropriately.

(5) In the vehicle according to (4),

the electric motor includes a stator (stator 52) in which a coil (coil 53) in which a conductor (conductor 60) is covered with an insulating film (insulating film 61) is wound, and a rotor (rotor 51), and

the temperature detection part detects temperature of the coil.

According to (5), it is possible to more appropriately recognize the durable life of the electric motor affected by the deterioration of the insulation performance of the insulating film covering the conductor.

(6) In the vehicle according to (5),

the coil includes a plurality of coil segments (coil segment 53a) and is configured such that segment end portions from which the insulating film is peeled off are joined together,

the temperature detection part is arranged near a joint part (joint part 62), and

the partial discharge inception voltage is set based on a partial discharge inception voltage reference value (base PDIV) in the vicinity of the joint part, the atmospheric pressure, a peripheral temperature in the vicinity of the joint part.

According to (6), since the partial discharge inception voltage is set based on the partial discharge inception voltage reference value in the vicinity of the joint part, the atmospheric pressure, the peripheral temperature in the vicinity of the joint part, the durable life of the electric motor can be recognized based on the portion of which the insulation performance is deteriorated most easily.

(7) In the vehicle according to (5) or (6),

the temperature detection part includes a plurality of temperature detection parts,

the plurality of temperature detection parts are arranged at different portions of the coil, and

the partial discharge inception voltage is set based on the partial discharge inception voltage reference value (base PDIV) of each portion, the atmospheric pressure, and temperature of each portion.

According to (7), since the partial discharge inception voltage is set based on the partial discharge inception voltage reference value of each portion, the atmospheric pressure, and the temperature of each portion, the durable life of the electric motor can be recognized based on states of the plural portions.

(8) The vehicle according to any one of (1) to (7) further includes:

a notification part (notification part D) which notifies an occupant when the number of times stored in the storage part exceeds a predetermined number of times.

According to (8), since the notification part which notifies the occupant when the number of times stored in the storage part exceeds the predetermined number of times, it is possible to urge the occupant to replace the electric motor near the end of the durable life.

(9) In the vehicle according to (8),

the notification part includes a visible display part or a speaker which generates warning sound.

According to (9), since the notification part includes a visible display part or a speaker which generates warning sound, it is possible to reliably notify the occupant of the fact that the number of times stored in the storage part exceeds the predetermined number of times.

1. A vehicle comprising:
an electric motor;
an electric motor control device which controls electric power to be supplied to the electric motor;
an atmospheric pressure detection part which detects atmospheric pressure; and
a storage part which stores the number of times that a voltage exceeding a partial discharge inception voltage set according to the atmospheric pressure detected by the atmospheric pressure detection part is input to the electric motor.

2. The vehicle according to claim 1, wherein
the electric motor control device limits a voltage to be supplied to the electric motor if the number of times stored in the storage part exceeds a predetermined number of times.

3. The vehicle according to claim 2, further comprising:
a power conversion device which converts the electric power to be supplied to the electric motor, wherein
the electric motor control device limits a boosting voltage output by the power conversion device.

4. The vehicle according to claim 1, further comprising:
a temperature detection part which detects temperature, wherein
the partial discharge inception voltage is set based on the atmospheric pressure detected by the atmospheric pressure detection part and the temperature detected by the temperature detection part.

5. The vehicle according to claim 4, wherein
the electric motor includes a stator in which a coil covered with an insulating film is wound and a rotor, and
the temperature detection part detects the temperature of the coil.

6. The vehicle according to claim 5, wherein
the coil includes a plurality of coil segments and is configured by joining together segment end portions from which the insulating film is peeled off,
the temperature detection part is arranged near a joint part, and
the partial discharge inception voltage is set based on a partial discharge inception voltage reference value in the vicinity of the joint part, the atmospheric pressure, and a peripheral temperature in the vicinity of the joint part.

7. The vehicle according to claim 5, wherein
the temperature detection part includes a plurality of temperature detection parts,
the plurality of temperature detection parts are arranged at different portions of the coil, and
the partial discharge inception voltage is set based on the partial discharge inception voltage reference value of each portion, the atmospheric pressure, and temperature of each portion.

8. The vehicle according to claim 1, further comprising:
a notification part which notifies an occupant when the number of times stored in the storage part exceeds a predetermined number of times.

9. The vehicle according to claim 8, wherein
the notification part includes a visible display part or a speaker which generates warning sound.
